(19) United States
(12) Patent Application Publication
(10) Pub. No.: US 2026/0292903 A1
(43) Pub. Date: Sep. 24, 2026

(54) COMMUNICATION METHOD, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/165,965

(22) PCT Filed: Mar. 17, 2023
(86) PCT No.: PCT/CN2023/082311

§ 371 Date: Sep. 16, 2025

(51) Int. Cl. H04W 76/12; H04W 52/02; H04W 76/14

(52) U.S. Cl. CPC H04W 76/12; H04W 52/0216; H04W 52/0235; H04W 76/14

(57) ABSTRACT

The embodiments of the present disclosure relate to the technical field of mobile communications. Provided are a communication method, an electronic device, and a storage medium. The communication method is applied to a first station (STA), and the method includes: determining a first frame, wherein the first frame indicates that the first STA requests to establish a TDLS peer PSM mechanism with a second STA on a first link, and the first link is a TDLS channel; and sending the first frame on a second link with an access point, and indicating the access point to forward the first frame to the second STA. Provided in the embodiments of the present disclosure is a method for establishing a TDLS peer PSM mechanism.

### CROSS-REFERENCE TO RELATED APPLICATION

The present application is a National Stage of International Application No. PCT/CN2023/082311, filed on Mar. 17, 2023, the entire disclosure of which is incorporated herein by reference for all purposes.

### TECHNICAL FIELD

The present disclosure relates to the field of mobile communication technology. Specifically, the present disclosure relates to a communication method, an electronic device, and a storage medium.

### BACKGROUND

With rapid development of mobile communication technology, Wireless Fidelity (Wi-Fi) technology has achieved significant progress in transmission speed and throughput. Currently, research on Wi-Fi technology, such as Ultra High Reliability (UHR), aims to improve the reliability of wireless local area network (WLAN) link, reduce latency, enhance manageability, increase throughput at different signal-to-noise ratio (SNR) levels, and reduce device-level power consumption, or the like. Furthermore, in UHR, in order to improve system throughput, a method for simultaneous communication in the sub-7 GHz and 45 GHz and/or 60 GHz frequency bands is proposed.

In UHR, the Tunneled Direct Link Setup (TDLS) mechanism is crucial for transmission of low-latency services. Furthermore, in order to save power, the TDLS peer power save mode (TDLS peer PSM) mechanism has been proposed. Therefore, a method for establishing the TDLS peer PSM mechanism is needed to achieve power saving of UHR.

### SUMMARY

Embodiments of the present disclosure provide a communication method, an electronic device, and a storage medium.

In one aspect, embodiments of the present disclosure provide a communication method, applied to a first station STA, including:
determining a first frame, wherein the first frame indicates that the first STA requests to establish a TDLS peer PSM mechanism with a second STA on a first link, and the first link is a TDLS channel; and
sending the first frame on a second link with an access point, and indicating the access point to forward the first frame to the second STA.

In another aspect, embodiments of the present disclosure further provide a communication method, applied to an access point AP, including:
receiving a first frame on a second link with a first station STA, wherein the first frame indicates that the first STA requests to establish a TDLS peer PSM mechanism with a second STA on a first link, and the first link is a TDLS channel; and
forwarding the first frame to a second STA.

In another aspect, embodiments of the present disclosure further provide a communication method, applied to a second station STA, including:
receiving a first frame forwarded by an access point AP, wherein the first frame is received by the AP on a second link with a first STA; the first frame indicates that the first STA requests to establish a TDLS peer PSM mechanism with a second STA on a first link, and the first link is a TDLS channel.

In another aspect, embodiments of the present disclosure further provide an electronic device, wherein the electronic device is a first station STA and includes:
a determining module, configured to determine a first frame, wherein the first frame indicates that the first STA requests to establish a TDLS peer PSM mechanism with a second STA on a first link, and the first link is a TDLS channel; and
a first sending module, configured to send the first frame on a second link with an access point, and indicate the access point to forward the first frame to the second STA.

In another aspect, an embodiment of the present disclosure further provides an electronic device, wherein the electronic device is an access point AP and includes:
a first receiving module, configured to receive a first frame on a second link with a first station STA, wherein the first frame indicates that the first STA requests to establish a TDLS peer PSM mechanism with a second STA on a first link, and the first link is a TDLS channel; and
a forwarding module, configured to forward the first frame to a second STA.

In another aspect, an embodiment of the present disclosure further provides an electronic device, wherein the electronic device is a second station STA and includes:
a second receiving module, configured to receive a first frame forwarded by an access point AP, wherein the first frame is received by the AP on a second link with a first STA; the first frame indicates that the first STA requests to establish a TDLS peer PSM mechanism with a second STA on a first link, and the first link is a TDLS channel.

An embodiment of the present disclosure further provides an electronic device, including a memory, a processor, and a computer program stored in the memory and executable by the processor, wherein the processor implements one or more methods described in the embodiments of the present disclosure when executing the program.

An embodiment of the present disclosure further provides a non-transitory computer-readable storage medium, having a computer program stored thereon, wherein the computer program implements one or more methods described in the embodiments of the present disclosure when executed by a processor.

Additional aspects and advantages of the embodiments of the present disclosure will be partially set forth in the following description and will become apparent from the description or through practice of the present disclosure.

### BRIEF DESCRIPTION OF THE DRAWINGS

In order to more clearly illustrate the technical solutions of the embodiments of the present disclosure, the drawings required for use in the description of the embodiments of the present disclosure will be briefly introduced below. The drawings in the following description are only some embodiments of the present disclosure. For ordinary technicians in this field, other drawings can also be obtained based on these drawings without paying creative labor.

FIG. 1 is a flowchart of a communication method provided in an embodiment of the present disclosure;

FIG. 2 is a schematic diagram of a first example of an embodiment of the present disclosure;

FIG. 3 is another flowchart of a communication method provided by an embodiment of the present disclosure;

FIG. 4 is still another flowchart of a communication method provided by an embodiment of the present disclosure;

FIG. 5 is a schematic diagram of an electronic device provided by an embodiment of the present disclosure;

FIG. 6 is another schematic diagram of an electronic device provided by an embodiment of the present disclosure;

FIG. 7 is still another schematic diagram of an electronic device provided by an embodiment of the present disclosure;

FIG. 8 is yet still another schematic diagram of an electronic device provided by an embodiment of the present disclosure.

### DETAILED DESCRIPTION

Here, the example embodiments will be described in detail, and examples thereof are shown in the accompanying drawings. Unless otherwise indicated, the same number in different drawings represents the same or similar element when the following description refers to the drawings. The implementations described in the following example embodiments do not represent all implementations consistent with the present disclosure. Instead, they are only examples of apparatuses and methods consistent with some aspects of the present disclosure as detailed in the appended claims.

In embodiments of the present disclosure, the used terms are only for the purpose of describing specific embodiments and are not intended to limit the present disclosure. The singular forms “a”, “said” and “the” used in the present disclosure and the appended claims are also intended to include plural forms, unless the context clearly indicates otherwise. It should also be understood that, the term “and/or” used herein refers to and includes any or all possible combinations of one or more associated listed items. For example, “A and/or B” may mean that A exists alone, A and B exist simultaneously, or B exists alone. The character “/” generally indicates an “or” relationship between the associated items. The term “plurality” refers to two or more. Therefore, in the embodiments of the present disclosure, “plurality” may also be understood as “at least two”.

It should be understood that, although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the word “if” used herein may be interpreted as “at . . . ” or “when . . . ” or “in response to determining”.

The technical solutions in the embodiments of the present disclosure will be described clearly and completely below in conjunction with the drawings in the embodiments of the present disclosure. The described embodiments are only part of the embodiments of the present disclosure, but not all embodiments. Based on the embodiments in the present disclosure, all other embodiments obtained by ordinary technicians in the field without creative work are within the protection scope of the present disclosure.

The embodiments of this disclosure provide a communication method, an electronic device, and a storage medium for establishing a TDLS peer PSM mechanism.

The method and the apparatus are based on the same application concept. Since the principles of solving the problem by the method and the apparatus are similar, the implementations of the apparatus and the method can refer to each other, and the repetitions are not repeated.

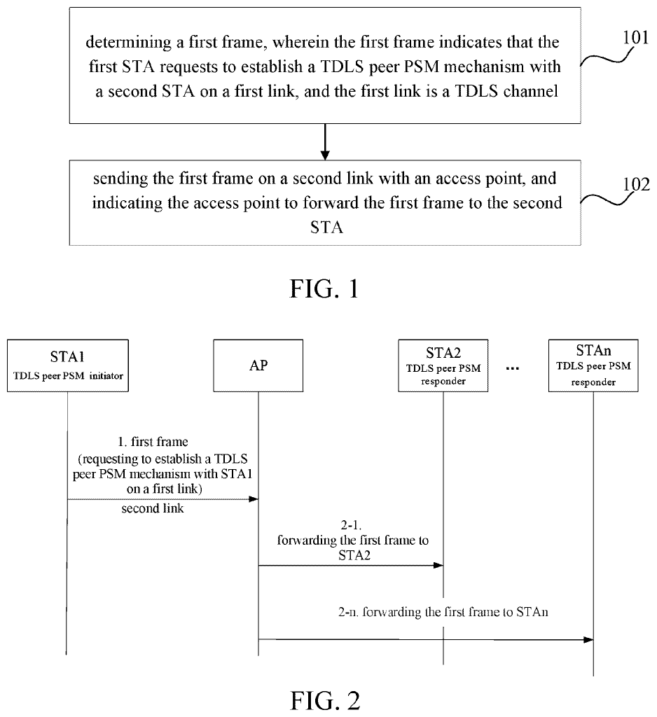

As shown in FIG. 1, an embodiment of the present disclosure provides a communication method. Optionally, the method can be applied to a first station (STA). Optionally, in this embodiment, an access point (AP), such as a device with a wireless-to-wired bridging functionality, extends the services provided by the wired network to the wireless network. The STA, such as an electronic device with a wireless network access functionality, provides frame delivery services to facilitate information delivery.

The method may include the following steps.

Step 101: a first frame is determined, the first frame indicates that the first STA requests to establish a TDLS peer PSM mechanism with a second STA on a first link, and the first link is a TDLS channel.

TDLS technology enables two STAs in the same Basic Service Set (BSS) to directly transmit data, bypassing the AP, after establishing a TDLS link. This allows direct transmission using the highest rate standard supported by both STAs, without being constrained by the AP. Direct transmission can occur on the original channel or switch to a new extended channel, which can avoid data transmission delay caused by network congestion and is crucial for the transmission of low-latency services. To save power, the TDLS peer PSM mechanism is proposed. Specifically, the TDLS peer PSM mechanism is a power-saving mechanism that can be used between TDLS peer STAs and is based on periodic wakeup scheduling. In the embodiments of the present disclosure, a first STA determines a first frame, such as a TDLS peer PSM request frame. This first frame indicates that the first STA requests to establish a TDLS peer PSM mechanism with a second STA on a first link, the first link is a TDLS channel. That is, the first STA, acting as a TDLS peer PSM initiator, requests to establish a TDLS peer PSM mechanism with a second STA, acting as a TDLS peer PSM responder.

Optionally, a plurality of first links can exist, that is, the first STA can establish TDLS links with a plurality of second STAs respectively.

Step 102, the first frame is sent on a second link with an access point, and the access point is indicated to forward the first frame to the second STA.

The first STA sends the first frame on the second link with the AP and requests the AP to forward the first frame to the second STA, i.e., establishing a TDLS peer PSM mechanism for the first link (TDLS link) on the second link. On one hand, it allows the first link to quickly enter a power-saving state. For example, the first link may be in a service data transmission state currently, establishing the TDLS peer PSM mechanism through the second link allows the first link to quickly enter a power-saving state, without affecting the currently transmitting service data. On the other hand, forwarding the first frame by the AP allows the AP to understand whether each link is in a power-saving state, which facilitates the AP to reasonably allocate network resources for each link.

It should be understood that in embodiments of the present disclosure, the AP and STA may be devices that support multiple links. For example, they may be represented as AP MLD and non-AP MLD, respectively. AP MLD may represent an access point that supports multi-link communication capabilities, and non-AP MLD may represent a station that supports multi-link communication capabilities. For ease of explanation, the following use AP and STA as examples, but this does not constitute a limitation of embodiments of the present disclosure.

As a first example, see FIG. 2, which illustrates an application scenario of the communication method provided by an embodiment of the present disclosure. STA1 acts as the TDLS peer PSM initiator, and STA2 to STAn act as TDLS peer PSM responders. STA1 and STA2 to STAn may each establish a TDLS link, i.e., a first link.

STA1 first performs the first step, sending a first frame, e.g., a TDLS peer PSM request frame, to the AP on the second link. The first frame indicates that the first STA requests to establish a TDLS peer PSM mechanism with the second STA on the first link.

The AP performs the second step (2-1, 2-2, . . . , 2-n, each sub-step can be performed simultaneously or sequentially). On the link with each TDLS peer PSM responder, the AP forwards the first frame to STA2 to STAn, respectively. This allows each of STA2 to STAn to establish a TDLS peer PSM mechanism with STA1 respectively based on the first frame.

An embodiment of the present disclosure provides a communication method, applied to a first STA, including:
determining a first frame, wherein the first frame indicates that the first STA requests to establish a TDLS peer PSM mechanism with a second STA on a first link, and the first link is a TDLS channel; and
sending the first frame on a second link with an access point, and indicating the access point to forward the first frame to the second STA.

The first frame includes a link identifier information element;
the link identifier information element includes:
basic service set (BSS) identifier BSSID information, address information (TDLS initiator STA Address) of a TDLS initiator of the first link, and address information (TDLS responder STA Address) of a TDLS responder of the first link.

As an example, the format of the link identifier information element is shown in Table 1 below:

TABLE 1

| | | | | TDLS | TDLS |
|---|---|---|---|---|---|
| | | | | initiator | responder |
| Information | Element | | | STA | STA |
| Content | ID | Length | BSSID | Address | Address |
| Octets | 1 | 1 | 6 | 6 | 6 |

The TDLS initiator of the first link is the STA that initiates the setup of the first link, hereinafter referred to as the initiator STA, and the TDLS responder of the first link is the STA that responds to the setup of the first link, hereinafter referred to as the responder STA.

Taking the first frame as a TDLS peer PSM request frame as an example, the identifier of its action field is shown in Table 2 below:

TABLE 2

| Order | Information |
|---|---|
| 1 | Category |
| 2 | TDLS Action |
| 3 | Dialog Token |
| 4 | Link Identifier |
| 5 | Wakeup Schedule |

This embodiment of the present disclosure provides a communication method, applied to a first STA, including:
determining a first frame, wherein the first frame indicates that the first STA requests to establish a TDLS peer PSM mechanism with a second STA on a first link, and the first link is a TDLS channel, the first frame includes a link identifier information element; and
sending the first frame on a second link with an access point, and indicating the access point to forward the first frame to the second STA;
wherein the link identifier information element includes:
basic service set identifier BSSID information, address information of a TDLS initiator of the first link, and address information of a TDLS responder of the first link.

In the first scenario, the TDLS initiator of the first link and the TDLS responder of the first link are multi-link devices, the address information of the TDLS initiator is MAC address information of the multi-link device, and the address information of the TDLS responder is MAC address information of the multi-link device.

In the second scenario, the TDLS initiator and/or the TDLS responder are not multi-link devices, the address information of the TDLS initiator is MAC address information of the TDLS initiator on the first link, and the address information of the TDLS responder is MAC address information of the TDLS responder on the first link.

In the first scenario, when both the TDLS initiator and the TDLS responder are multi-link devices, their respective address information is the MAC address information of the corresponding multi-link device.

In the second scenario, when at least one of the TDLS initiator and the TDLS responder is not a multi-link device, their address information is the respective MAC address information on the first link.

In addition, there may be a third and/or fourth scenario.

In the third scenario, the TDLS initiator of the first link is a multi-link device, for example, the initiator STA is a non-AP MLD, then the TDLS initiator address information is the MAC address information of the multi-link device, i.e., the MAC address of the non-AP MLD. If the TDLS initiator of the first link is not a multi-link device, the TDLS initiator address information is the MAC address information of the TDLS initiator on the first link, i.e., the MAC address of the initiator STA on the first link.

In the fourth scenario, the TDLS responder of the first link is a multi-link device, for example, the responder STA is a non-AP MLD, the TDLS responder address information is the MAC address information of the multi-link device, i.e., the MAC address of the non-AP MLD. If the TDLS responder of the first link is not a multi-link device, the TDLS responder address information is the MAC address information of the TDLS responder on the first link, i.e., the MAC address of the responder STA on the first link.

The embodiments of the present disclosure provide a communication method, applied to a first STA, including:
determining a first frame, wherein the first frame indicates that the first STA requests to establish a TDLS peer PSM mechanism with a second STA on a first link, and the first link is a TDLS channel, the first frame includes a link identifier information element; and
sending the first frame on a second link with an access point, and indicating the access point to forward the first frame to the second STA;
the link identifier information element includes:
basic service set identifier BSSID information, address information of a TDLS initiator of the first link, and address information of a TDLS responder of the first link.

The BSSID information includes: BSSID of an access point corresponding to a third link; the third link is a link used to establish the first link, and the third link is a link for establishing the first link (TDLS link), for example, a link between the initiator STA and an AP (i.e., the AP corresponding to the third link for establishing the first link), or a link between the AP and the responder STA.

The BSSID information includes the BSSID to which the STA belongs. In a wireless local area network, a BSS may consist of an AP and one or more STAs communicating with the AP. The BSSID to which an access point belongs may be the MLD MAC address of the AP MLD within the BSS to which the access point belongs.

The embodiments of the present disclosure provide a communication method, applied to a first STA, including:
determining a first frame, wherein the first frame indicates that the first STA requests to establish a TDLS peer PSM mechanism with a second STA on a first link, and the first link is a TDLS channel, the first frame includes a link identifier information element;
the link identifier information element includes:
basic service set identifier BSSID information, address information of a TDLS initiator of the first link, and address information of a TDLS responder of the first link.

The first frame is sent on a second link with the access point, the access point is indicated to forward the first frame to the second STA.

The first frame includes: one or more wakeup schedule information elements, and the link identifier information element corresponding to each wakeup schedule information element. That is, the first frame may include wakeup schedule information element of one link or wakeup schedule information elements of multiple links; each wakeup schedule information element corresponds to one link.

For example, the format of the link identifier information element is shown in Table 3 below:

TABLE 3

| | Information Content | | | | | | |
|---|---|---|---|---|---|---|---|
| | | | | | Awake | Maximum | |
| | Element | | | | window | Awake Window | idle |
| | ID | Length | Offset | interval | Slots | Duration | Count |
| Octets | 1 | 1 | 4 | 4 | 4 | 4 | 2 |

The Maximum Awake Window Duration field is set to the maximum duration of the wakeup window, in units of microseconds.

The Idle Count field is set to the number of consecutive wakeup windows in which no individually addressed frames are received from the TDLS peer STA before the TDLS peer STA deletes the wakeup schedule.

The embodiments of the present disclosure provide a communication method, applied to a first STA, including:
determining a first frame, wherein the first frame indicates that the first STA requests to establish a TDLS peer PSM mechanism with a second STA on a first link, and the first link is a TDLS channel, the first frame includes a link identifier information element;
the link identifier information element includes:
basic service set identifier BSSID information, address information of a TDLS initiator of the first link, and address information of a TDLS responder of the first link.

The first frame is sent on a second link with the access point, the access point is indicated to forward the first frame to the second STA.

The first frame includes: one or more wakeup schedule information elements, and the link identifier information element corresponding to each wakeup schedule information element.

An identifier of the wakeup schedule information element is set to a value of the BSSID information in the corresponding link identifier information element, i.e., the BSSID of the access point corresponding to a third link; the third link is the link for establishing the first link.

The embodiments of the present disclosure provide a communication method, applied to a first STA, including:
determining a first frame, wherein the first frame indicates that the first STA requests to establish a TDLS peer PSM mechanism with a second STA on a first link, and the first link is a TDLS channel, the first frame includes a link identifier information element;
sending the first frame on a second link with the access point, indicating the access point to forward the first frame to the second STA.

The link identifier information element includes:
basic service set identifier BSSID information, address information of a TDLS initiator of the first link, and address information of a TDLS responder of the first link.

The first frame includes: one or more wakeup schedule information elements, and the link identifier information element corresponding to each wakeup schedule information element.

The wakeup schedule information element includes a Time Synchronization Function (TSF) parameter, which is used for time function synchronization of the corresponding link. The TSF parameter is set to a TSF parameter value in a beacon frame broadcast by the BSSID in the corresponding link identifier information element, or to a TSF parameter value of a link used to send a TDLS setup request frame. The TDLS peer PSM responder can perform time synchronization based on the TSF parameter.

For example, the time value of the first link at the current moment is determined based on the TSF parameter value in the beacon and the preset time difference between the first link and the link that sends the beacon. Alternatively, the time value of the first link at the current moment is determined based on the TSF parameter value of the link that sends the TDLS setup request frame and the preset time difference between the first link and the link that sends the TDLS setup request frame.

The embodiments of the present disclosure provide a communication method, applied to a first STA, including:
determining a first frame, wherein the first frame indicates that the first STA requests to establish a TDLS peer PSM mechanism with a second STA on a first link, and the first link is a TDLS channel;
sending the first frame on a second link with the access point, indicating the access point to forward the first frame to the second STA.

Optionally, the first frame includes a link identifier information element;
the link identifier information element includes:
basic service set identifier BSSID information, address information of a TDLS initiator of the first link, and address information of a TDLS responder of the first link.

Optionally, the TDLS initiator of the first link and the TDLS responder of the first link are multi-link devices, the address information of the TDLS initiator is MAC address information of the multi-link device, and the address information of the TDLS responder is MAC address information of the multi-link device;
the TDLS initiator and/or the TDLS responder are not multi-link devices, the address information of the TDLS initiator is MAC address information of the TDLS initiator on the first link, and the address information of the TDLS responder is MAC address information of the TDLS responder on the first link.

Optionally, the BSSID information includes: BSSID of an access point corresponding to a third link; the third link is a link used to establish the first link.

Optionally, the first frame includes: one or more wakeup schedule information elements, and the link identifier information element corresponding to each wakeup schedule information element.

Optionally, an identifier of the wakeup schedule information element is set to a value of the BSSID information in the corresponding link identifier information element.

Optionally, the wakeup schedule information element includes a time synchronization function TSF parameter, and the TSF parameter is set to a TSF parameter value in a beacon frame broadcast by the BSSID in the corresponding link identifier information element, or to a TSF parameter value of a link used to send a TDLS setup request frame.

Optionally, the first frame includes a TDLS peer PSM request frame.

In embodiments of the present disclosure, a first STA sends a first frame on a second link with an AP, requesting the AP to forward the first frame to the second STA, thereby achieving the establishment of a TDLS peer PSM mechanism for the first link on the second link. On one hand, establishing the TDLS peer PSM mechanism through the second link enables the first link to quickly enter a power-saving state; on the other hand, forwarding the first frame by the AP allows the AP to understand whether each link is in a power-saving state, which facilitates the AP to reasonably allocate network resources for each link.

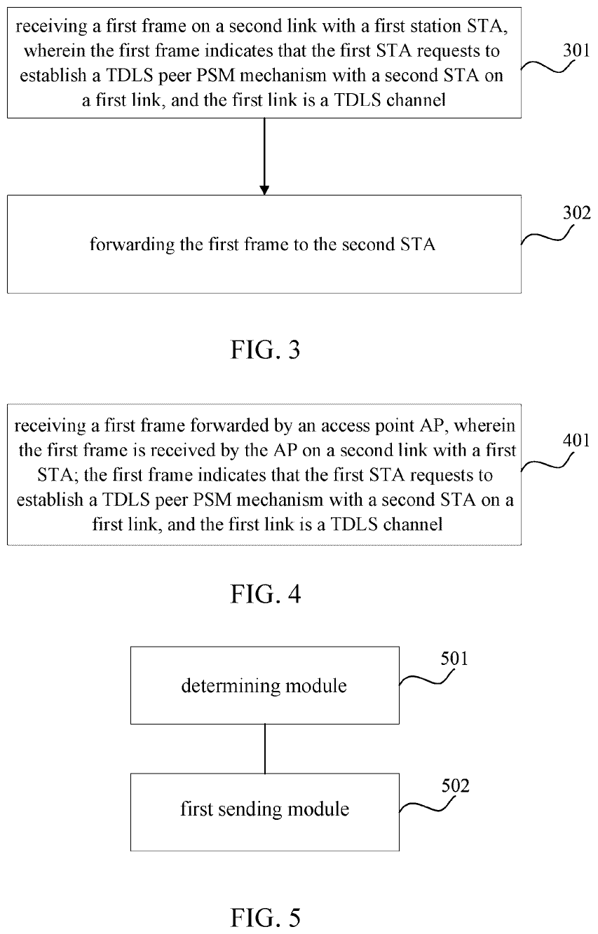

Referring to FIG. 3, an embodiment of the present disclosure provides a communication method, optionally, the method is applied to an access point AP. The method may include the following steps:

Step 301: receiving a first frame on a second link with a first station STA, wherein the first frame indicates that the first STA requests to establish a TDLS peer PSM mechanism with a second STA on a first link, and the first link is a TDLS channel.

The TDLS peer PSM mechanism is a power-saving mechanism that can be used between TDLS peer STAs and is based on periodic wakeup scheduling. In the embodiment of the present disclosure, an AP receives a first frame, such as a TDLS peer PSM request frame. This first frame indicates that the first STA requests to establish a TDLS peer PSM mechanism with a second STA on a first link, the first link is a TDLS channel. That is, the first STA, acting as a TDLS peer PSM initiator, requests to establish a TDLS peer PSM mechanism with a second STA, acting as a TDLS peer PSM responder.

Optionally, a plurality of first links can exist, that is, the first STA can establish TDLS links with a plurality of second STAs respectively.

Step 302, the first frame is forwarded to the second STA.

The AP sends the first frame on the link with the second STA. That is, the first STA establishes a TDLS peer PSM mechanism for the first link (TDLS link) on the second link through the AP. Referring to the first example above, the AP performs the second step (2-1, 2-2, . . . , 2-n; each sub-step can be performed simultaneously or sequentially). On the link with each TDLS peer PSM responder, the AP forwards the first frame to STA2 to STAn, respectively. This allows each of STA2 to STAn to establish a TDLS peer PSM mechanism with STA1 respectively based on the first frame.

On one hand, it allows the first link to quickly enter a power-saving state. For example, the first link may be in a service data transmission state currently, establishing the TDLS peer PSM mechanism through the second link allows the first link to quickly enter a power-saving state, without affecting the currently transmitting service data. On the other hand, forwarding the first frame by the AP allows the AP to understand whether each link is in a power-saving state, which facilitates the AP to reasonably allocate network resources for each link.

The present disclosure provides a communication method, which may be optionally applied to an access point AP. The method may include the following steps:
receiving a first frame on a second link with a first station STA, wherein the first frame indicates that the first STA requests to establish a TDLS peer PSM mechanism with a second STA on a first link, and the first link is a TDLS channel; and
forwarding the first frame to a second STA.

The link identifier information element includes:
basic service set identifier BSSID information, address information (TDLS initiator STA Address) of a TDLS initiator of the first link, and address information (TDLS responder STA Address) of a TDLS responder of the first link. As an example, the format of the link identifier information element is as shown in Table 1 above. The TDLS initiator of the first link is the STA that initiates the setup of the first link (hereinafter referred to as the initiator STA), and the TDLS responder of the first link is the STA that responds to the setup of the first link (hereinafter referred to as the responder STA).

The present disclosure provides a communication method, which may be optionally applied to an access point AP. The method may include the following steps:
receiving a first frame on a second link with a first station STA, wherein the first frame indicates that the first STA requests to establish a TDLS peer PSM mechanism with a second STA on a first link, and the first link is a TDLS channel; and
forwarding the first frame to a second STA.

The link identifier information element includes:
basic service set identifier BSSID information, address information of a TDLS initiator of the first link, and address information of a TDLS responder of the first link.

In the first scenario, the TDLS initiator of the first link and the TDLS responder of the first link are multi-link devices, the address information of the TDLS initiator is MAC address information of the multi-link device, and the address information of the TDLS responder is MAC address information of the multi-link device.

In the second scenario, the TDLS initiator and/or the TDLS responder are not multi-link devices, the address information of the TDLS initiator is MAC address information of the TDLS initiator on the first link, and the address information of the TDLS responder is MAC address information of the TDLS responder on the first link.

In the first scenario, when both the TDLS initiator and the TDLS responder are multi-link devices, their respective address information is the MAC address information of the corresponding multi-link device.

In the second scenario, when at least one of the TDLS initiator and the TDLS responder is not a multi-link device, their address information is the respective MAC address information on the first link.

In addition, there may be a third and/or fourth scenario.

In the third scenario, the TDLS initiator of the first link is a multi-link device, for example, the initiator STA is a non-AP MLD, then the TDLS initiator address information is the MAC address information of the multi-link device, i.e., the MAC address of the non-AP MLD. If the TDLS initiator of the first link is not a multi-link device, the TDLS initiator address information is the MAC address information of the TDLS initiator on the first link, i.e., the MAC address of the initiator STA on the first link.

In the fourth scenario, the TDLS responder of the first link is a multi-link device, for example, the responder STA is a non-AP MLD, the TDLS responder address information is the MAC address information of the multi-link device, i.e., the MAC address of the non-AP MLD. If the TDLS responder of the first link is not a multi-link device, the TDLS responder address information is the MAC address information of the TDLS responder on the first link, i.e., the MAC address of the responder STA on the first link.

The present disclosure provides a communication method, which may be optionally applied to an access point AP. The method may include the following steps:
receiving a first frame on a second link with a first station STA, wherein the first frame indicates that the first STA requests to establish a TDLS peer PSM mechanism with a second STA on a first link, and the first link is a TDLS channel; and
forwarding the first frame to a second STA.

The link identifier information element includes:
basic service set identifier BSSID information, address information of a TDLS initiator of the first link, and address information of a TDLS responder of the first link.

The BSSID information includes: BSSID of an access point corresponding to a third link; the third link is a link used to establish the first link, and the third link is a link for establishing the first link (TDLS link), for example, a link between the initiator STA and an AP (i.e., the AP corresponding to the third link for establishing the first link), or a link between the AP and the responder STA.

The BSSID information includes the BSSID to which the STA belongs. In a wireless local area network, a BSS may consist of an AP and one or more STAs communicating with the AP.

The present disclosure provides a communication method, which may be optionally applied to an access point AP. The method may include the following steps:
receiving a first frame on a second link with a first station STA, wherein the first frame indicates that the first STA requests to establish a TDLS peer PSM mechanism with a second STA on a first link, and the first link is a TDLS channel; and
forwarding the first frame to a second STA.

The link identifier information element includes:
basic service set identifier BSSID information, address information of a TDLS initiator of the first link, and address information of a TDLS responder of the first link.

The first frame includes: one or more wakeup schedule information elements, and the link identifier information element corresponding to each wakeup schedule information element. That is, the first frame may include wakeup schedule information element of one link or wakeup schedule information elements of multiple links; each wakeup schedule information element corresponds to one link.

For example, the format of the link identifier information element is shown in Table 2 above. The Maximum Awake Window Duration field is set to the maximum duration of the wakeup window, in units of microseconds.

The Idle Count field is set to the number of consecutive wakeup windows in which no individually addressed frames are received from the TDLS peer STA before the TDLS peer STA deletes the wakeup schedule.

The present disclosure provides a communication method, which may be optionally applied to an access point AP. The method may include the following steps:
receiving a first frame on a second link with a first station STA, wherein the first frame indicates that the first STA requests to establish a TDLS peer PSM mechanism with a second STA on a first link, and the first link is a TDLS channel; and
forwarding the first frame to a second STA.

The link identifier information element includes:
basic service set identifier BSSID information, address information of a TDLS initiator of the first link, and address information of a TDLS responder of the first link.

The first frame includes: one or more wakeup schedule information elements, and the link identifier information element corresponding to each wakeup schedule information element. An identifier of the wakeup schedule information element is set to a value of the BSSID information in the corresponding link identifier information element, i.e., the BSSID of the access point corresponding to a third link; the third link is the link for establishing the first link.

The present disclosure provides a communication method, which may be optionally applied to an access point AP. The method may include the following steps:
receiving a first frame on a second link with a first station STA, wherein the first frame indicates that the first STA requests to establish a TDLS peer PSM mechanism with a second STA on a first link, and the first link is a TDLS channel; and
forwarding the first frame to a second STA.

The link identifier information element includes:
basic service set identifier BSSID information, address information of a TDLS initiator of the first link, and address information of a TDLS responder of the first link.

The first frame includes: one or more wakeup schedule information elements, and the link identifier information element corresponding to each wakeup schedule information element. The wakeup schedule information element includes a Time Synchronization Function TSF parameter, which is used for time function synchronization of the corresponding link. The TSF parameter is set to a TSF parameter value in a beacon frame broadcast by the BSSID in the corresponding link identifier information element, or to a TSF parameter value of a link used to send a TDLS setup request frame. The TDLS peer PSM responder can perform time synchronization based on the TSF parameter.

For example, the time value of the first link at the current moment is determined based on the TSF parameter value in the beacon and the preset time difference between the first link and the link that sends the beacon. Alternatively, the time value of the first link at the current moment is determined based on the TSF parameter value of the link that sends the TDLS setup request frame and the preset time difference between the first link and the link that sends the TDLS setup request frame.

The present disclosure provides a communication method, which may be optionally applied to an access point AP. The method may include the following steps:
receiving a first frame on a second link with a first station STA, wherein the first frame indicates that the first STA requests to establish a TDLS peer PSM mechanism with a second STA on a first link, and the first link is a TDLS channel; and
forwarding the first frame to a second STA.

Optionally, the first frame includes a link identifier information element;
the link identifier information element includes:
basic service set identifier BSSID information, address information of a TDLS initiator of the first link, and address information of a TDLS responder of the first link.

Optionally, the TDLS initiator of the first link and the TDLS responder of the first link are multi-link devices, the address information of the TDLS initiator is MAC address information of the multi-link device, and the address information of the TDLS responder is MAC address information of the multi-link device;
the TDLS initiator and/or the TDLS responder are not multi-link devices, the address information of the TDLS initiator is MAC address information of the TDLS initiator on the first link, and the address information of the TDLS responder is MAC address information of the TDLS responder on the first link.

Optionally, the BSSID information includes: BSSID of an access point corresponding to a third link; the third link is a link used to establish the first link.

Optionally, the first frame includes: one or more wakeup schedule information elements, and the link identifier information element corresponding to each wakeup schedule information element.

Optionally, an identifier of the wakeup schedule information element is set to a value of the BSSID information in the corresponding link identifier information element.

Optionally, the wakeup schedule information element includes a time synchronization function TSF parameter, and the TSF parameter is set to a TSF parameter value in a beacon frame broadcast by the BSSID in the corresponding link identifier information element, or to a TSF parameter value of a link used to send a TDLS setup request frame.

Optionally, the first frame includes a TDLS peer PSM request frame.

In the embodiment of the present disclosure, an AP receives a first frame on a second link with a first STA and forwards the first frame to the second STA, thereby achieving the establishment of a TDLS peer PSM mechanism for the first link on the second link. On one hand, establishing the TDLS peer PSM mechanism through the second link enables the first link to quickly enter a power-saving state; on the other hand, forwarding the first frame by the AP allows the AP to understand whether each link is in a power-saving state, which facilitates the AP to reasonably allocate network resources for each link.

Referring to FIG. 4, an embodiment of the present disclosure provides a communication method. Optionally, the method may be applied to a second station STA. The method may include the following step:

Step 401: receiving a first frame forwarded by an access point AP, wherein the first frame is received by the AP on a second link with a first STA; the first frame indicates that the first STA requests to establish a TDLS peer PSM mechanism with a second STA on a first link, and the first link is a TDLS channel.

The TDLS peer PSM mechanism is a power-saving mechanism that can be used between TDLS peer STAs and is based on periodic wakeup scheduling. In the embodiment of the present disclosure, a second STA receives a first frame forwarded by an AP, such as a TDLS peer PSM request frame. This first frame indicates that the first STA requests to establish a TDLS peer PSM mechanism with a second STA on a first link, the first link is a TDLS channel. That is, the first STA, acting as a TDLS peer PSM initiator, requests to establish a TDLS peer PSM mechanism with a second STA, acting as a TDLS peer PSM responder. On one hand, it allows the first link to quickly enter a power-saving state. For example, the first link may be in a service data transmission state currently, establishing the TDLS peer PSM mechanism through the second link allows the first link to quickly enter a power-saving state, without affecting the currently transmitting service data. On the other hand, forwarding the first frame by the AP allows the AP to understand whether each link is in a power-saving state, which facilitates the AP to reasonably allocate network resources for each link.

Optionally, a plurality of first links can exist, that is, the first STA can establish TDLS links with a plurality of second STAs respectively.

An embodiment of the present disclosure provides a communication method. Optionally, the method may be applied to a second station STA. The method may include the following step:
receiving a first frame forwarded by an access point AP, wherein the first frame is received by the AP on a second link with a first STA; the first frame indicates that the first STA requests to establish a TDLS peer PSM mechanism with a second STA on a first link, and the first link is a TDLS channel.

The first frame includes a link identifier information element;
the link identifier information element includes:
basic service set identifier BSSID information, address information (TDLS initiator STA Address) of a TDLS initiator of the first link, and address information (TDLS responder STA Address) of a TDLS responder of the first link. As an example, the format of the link identifier information element is as shown in Table 1 above. The TDLS initiator of the first link is the STA that initiates the setup of the first link (hereinafter referred to as the initiator STA), and the TDLS responder of the first link is the STA that responds to the setup of the first link (hereinafter referred to as the responder STA).

An embodiment of the present disclosure provides a communication method. Optionally, the method may be applied to a second station STA. The method may include the following step:
receiving a first frame forwarded by an access point AP, wherein the first frame is received by the AP on a second link with a first STA; the first frame indicates that the first STA requests to establish a TDLS peer PSM mechanism with a second STA on a first link, and the first link is a TDLS channel.

The first frame includes a link identifier information element;
the link identifier information element includes:
basic service set identifier BSSID information, address information of a TDLS initiator of the first link, and address information of a TDLS responder of the first link.

In the first scenario, the TDLS initiator of the first link and the TDLS responder of the first link are multi-link devices, the address information of the TDLS initiator is MAC address information of the multi-link device, and the address information of the TDLS responder is MAC address information of the multi-link device.

In the second scenario, the TDLS initiator and/or the TDLS responder are not multi-link devices, the address information of the TDLS initiator is MAC address information of the TDLS initiator on the first link, and the address information of the TDLS responder is MAC address information of the TDLS responder on the first link.

In the first scenario, when both the TDLS initiator and the TDLS responder are multi-link devices, their respective address information is the MAC address information of the corresponding multi-link device.

In the second scenario, when at least one of the TDLS initiator and the TDLS responder is not a multi-link device, their address information is the respective MAC address information on the first link.

In addition, there may be a third and/or fourth scenario.

In the third scenario, the TDLS initiator of the first link is a multi-link device, for example, the initiator STA is a non-AP MLD, then the TDLS initiator address information is the MAC address information of the multi-link device, i.e., the MAC address of the non-AP MLD. If the TDLS initiator of the first link is not a multi-link device, the TDLS initiator address information is the MAC address information of the TDLS initiator on the first link, i.e., the MAC address of the initiator STA on the first link.

In the fourth scenario, the TDLS responder of the first link is a multi-link device, for example, the responder STA is a non-AP MLD, the TDLS responder address information is the MAC address information of the multi-link device, i.e., the MAC address of the non-AP MLD. If the TDLS responder of the first link is not a multi-link device, the TDLS responder address information is the MAC address information of the TDLS responder on the first link, i.e., the MAC address of the responder STA on the first link.

An embodiment of the present disclosure provides a communication method. Optionally, the method may be applied to a second station STA. The method may include the following step:
receiving a first frame forwarded by an access point AP, wherein the first frame is received by the AP on a second link with a first STA; the first frame indicates that the first STA requests to establish a TDLS peer PSM mechanism with a second STA on a first link, and the first link is a TDLS channel.

The first frame includes a link identifier information element;
the link identifier information element includes:
basic service set identifier BSSID information, address information of a TDLS initiator of the first link, and address information of a TDLS responder of the first link.

The BSSID information includes: BSSID of an access point corresponding to a third link; the third link is a link used to establish the first link, and the third link is a link for establishing the first link (TDLS link), for example, a link between the initiator STA and an AP (i.e., the AP corresponding to the third link for establishing the first link), or a link between the AP and the responder STA. The BSSID information includes the BSSID to which the STA belongs. In a wireless local area network, a BSS may consist of an AP and one or more STAs communicating with the AP.

An embodiment of the present disclosure provides a communication method. Optionally, the method may be applied to a second station STA. The method may include the following step:
receiving a first frame forwarded by an access point AP, wherein the first frame is received by the AP on a second link with a first STA; the first frame indicates that the first STA requests to establish a TDLS peer PSM mechanism with a second STA on a first link, and the first link is a TDLS channel.

The first frame includes a link identifier information element;
the link identifier information element includes:
basic service set identifier BSSID information, address information of a TDLS initiator of the first link, and address information of a TDLS responder of the first link.

The first frame includes: one or more wakeup schedule information elements, and the link identifier information element corresponding to each wakeup schedule information element. That is, the first frame may include wakeup schedule information element of one link or wakeup schedule information elements of multiple links; each wakeup schedule information element corresponds to one link.

For example, the format of the link identifier information element is shown in Table 2 above. The Maximum Awake Window Duration field is set to the maximum duration of the wakeup window, in units of microseconds.

The Idle Count field is set to the number of consecutive wakeup windows in which no individually addressed frames are received from the TDLS peer STA before the TDLS peer STA deletes the wakeup schedule.

An embodiment of the present disclosure provides a communication method. Optionally, the method may be applied to a second station STA. The method may include the following step:
receiving a first frame forwarded by an access point AP, wherein the first frame is received by the AP on a second link with a first STA; the first frame indicates that the first STA requests to establish a TDLS peer PSM mechanism with a second STA on a first link, and the first link is a TDLS channel.

The first frame includes a link identifier information element;
the link identifier information element includes:
basic service set identifier BSSID information, address information of a TDLS initiator of the first link, and address information of a TDLS responder of the first link.

The first frame includes: one or more wakeup schedule information elements, and the link identifier information element corresponding to each wakeup schedule information element.

An identifier of the wakeup schedule information element is set to a value of the BSSID information in the corresponding link identifier information element, i.e., the BSSID of the access point corresponding to a third link; the third link is the link for establishing the first link.

An embodiment of the present disclosure provides a communication method. Optionally, the method may be applied to a second station STA. The method may include the following step:
receiving a first frame forwarded by an access point AP, wherein the first frame is received by the AP on a second link with a first STA; the first frame indicates that the first STA requests to establish a TDLS peer PSM mechanism with a second STA on a first link, and the first link is a TDLS channel.

The first frame includes a link identifier information element;
the link identifier information element includes:
basic service set identifier BSSID information, address information of a TDLS initiator of the first link, and address information of a TDLS responder of the first link.

The first frame includes: one or more wakeup schedule information elements, and the link identifier information element corresponding to each wakeup schedule information element. The wakeup schedule information element includes a Time Synchronization Function TSF parameter, which is used for time function synchronization of the corresponding link. The TSF parameter is set to a TSF parameter value in a beacon frame broadcast by the BSSID in the corresponding link identifier information element, or to a TSF parameter value of a link used to send a TDLS setup request frame. The TDLS peer PSM responder can perform time synchronization based on the TSF parameter.

For example, the time value of the first link at the current moment is determined based on the TSF parameter value in the beacon and the preset time difference between the first link and the link that sends the beacon. Alternatively, the time value of the first link at the current moment is determined based on the TSF parameter value of the link that sends the TDLS setup request frame and the preset time difference between the first link and the link that sends the TDLS setup request frame.

An embodiment of the present disclosure provides a communication method. Optionally, the method may be applied to a second station STA. The method may include the following step:
receiving a first frame forwarded by an access point AP, wherein the first frame is received by the AP on a second link with a first STA; the first frame indicates that the first STA requests to establish a TDLS peer PSM mechanism with a second STA on a first link, and the first link is a TDLS channel.

Optionally, the first frame includes a link identifier information element;
the link identifier information element includes:
basic service set identifier BSSID information, address information of a TDLS initiator of the first link, and address information of a TDLS responder of the first link.

Optionally, the TDLS initiator of the first link and the TDLS responder of the first link are multi-link devices, the address information of the TDLS initiator is MAC address information of the multi-link device, and the address information of the TDLS responder is MAC address information of the multi-link device;
the TDLS initiator and/or the TDLS responder are not multi-link devices, the address information of the TDLS initiator is MAC address information of the TDLS initiator on the first link, and the address information of the TDLS responder is MAC address information of the TDLS responder on the first link.

Optionally, the BSSID information includes: BSSID of an access point corresponding to a third link; the third link is a link used to establish the first link.

Optionally, the first frame includes: one or more wakeup schedule information elements, and the link identifier information element corresponding to each wakeup schedule information element.

Optionally, an identifier of the wakeup schedule information element is set to a value of the BSSID information in the corresponding link identifier information element.

Optionally, the wakeup schedule information element includes a time synchronization function TSF parameter, and the TSF parameter is set to a TSF parameter value in a beacon frame broadcast by the BSSID in the corresponding link identifier information element, or to a TSF parameter value of a link used to send a TDLS setup request frame.

Optionally, the first frame includes a TDLS peer PSM request frame.

In this embodiment of the present disclosure, the second STA receives the first frame forwarded by the AP, thereby achieving the establishment of a TDLS peer PSM mechanism for the first link on the second link. On one hand, establishing the TDLS peer PSM mechanism through the second link enables the first link to quickly enter a power-saving state; on the other hand, forwarding the first frame by the AP allows the AP to understand whether each link is in a power-saving state, which facilitates the AP to reasonably allocate network resources for each link.

Referring to FIG. 5, based on the same principles as the method provided in this embodiment of the present disclosure, the embodiment of the present disclosure also provides an electronic device, the electronic device is a first station STA. The electronic device includes:
a determining module 501, configured to determine a first frame, wherein the first frame indicates that the first STA requests to establish a TDLS peer PSM mechanism with a second STA on a first link, and the first link is a TDLS channel; and
a first sending module 502, configured to send the first frame on a second link with an access point, and indicate the access point to forward the first frame to the second STA.

The present disclosure also provides a communication apparatus, applied to a first station STA. The apparatus includes:
a frame determining module, configured to determine a first frame, wherein the first frame indicates that the first STA requests to establish a TDLS peer PSM mechanism with a second STA on a first link, and the first link is a TDLS channel; and
a first frame sending module, configured to send the first frame on a second link with an access point, and indicate the access point to forward the first frame to the second STA.

The apparatus also includes other modules of the electronic device in the aforementioned embodiments, which are not described here.

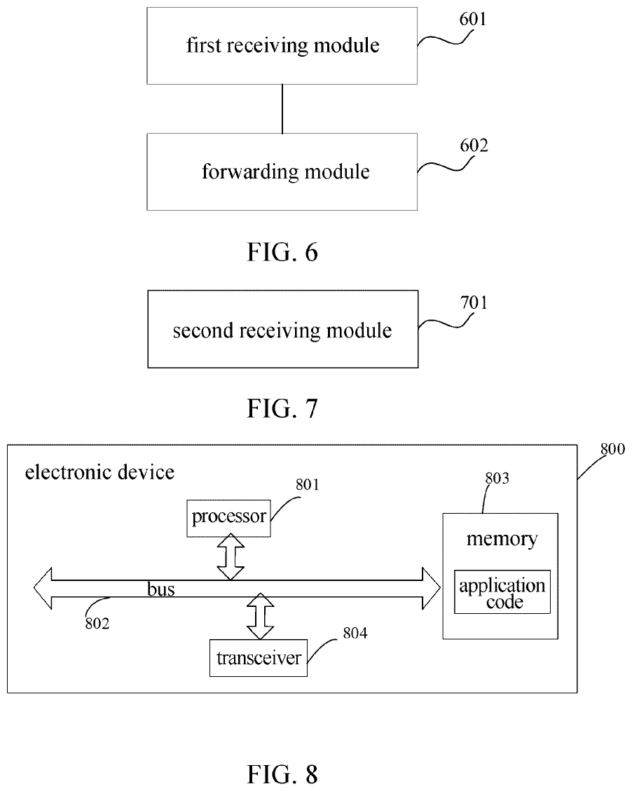

Referring to FIG. 6, based on the same principles as the method provided in the present disclosure, the embodiment of the present disclosure also provides an electronic device, electronic device is the first station STA, includes:
a first receiving module 601, configured to receive a first frame on a second link with a first station STA, wherein the first frame indicates that the first STA requests to establish a TDLS peer PSM mechanism with a second STA on a first link, and the first link is a TDLS channel; and
a forwarding module 602, configured to forward the first frame to a second STA.

The present disclosure also provides a communication apparatus, applied to a first station STA. The apparatus includes:
a first frame receiving module, configured to receive a first frame on a second link with a first station STA, wherein the first frame indicates that the first STA requests to establish a TDLS peer PSM mechanism with a second STA on a first link, and the first link is a TDLS channel; and
a frame forwarding module, configured to forward the first frame to a second STA.

The apparatus also includes other modules of the electronic device in the aforementioned embodiments, which are not described here.

Referring to FIG. 7, based on the same principles as the method provided in the present disclosure, the embodiment of the present disclosure also provides an electronic device, which is a first station STA, and the electronic device includes:
a second receiving module 701, configured to receive a first frame forwarded by an access point AP, wherein the first frame is received by the AP on a second link with a first STA; the first frame indicates that the first STA requests to establish a TDLS peer PSM mechanism with a second STA on a first link, and the first link is a TDLS channel.

The present disclosure also provides a communication apparatus, applied to a first station STA, and the apparatus includes:
a second frame receiving module, configured to receive a first frame forwarded by an access point AP, wherein the first frame is received by the AP on a second link with a first STA; the first frame indicates that the first STA requests to establish a TDLS peer PSM mechanism with a second STA on a first link, and the first link is a TDLS channel.

The apparatus also includes other modules of the electronic device described in the aforementioned embodiments, which are not described here.

In an optional embodiment, the embodiment of the present disclosure also provides an electronic device, as shown in FIG. 8, the electronic device 800 shown in FIG. 8 can be a server, including: a processor 801 and a memory 803. The processor 801 and the memory 803 are connected, such as through a bus 802. Optionally, the electronic device 800 may also include a transceiver 804. It should be noted that in actual applications, the transceiver 804 is not limited to one, and the structure of the electronic device 800 does not constitute a limitation on the embodiments of the present disclosure.

The processor 801 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components or any combination thereof. It can implement or execute various example logic blocks, modules and circuits described in conjunction with the content of the present disclosure. The processor 801 may also be a combination that implements computing functions, such as a combination including one or more microprocessors, a combination of a DSP and a microprocessor, etc.

The bus 802 may include a path to transmit information between the above components. The bus 802 may be a PCI (Peripheral Component Interconnect) bus or an EISA (Extended Industry Standard Architecture) bus, etc. The bus 802 can be divided into an address bus, a data bus, a control bus, etc. For ease of representation, only one thick line is used in FIG. 8, but it does not mean that there is only one bus or one type of bus.

The memory 803 may be a ROM (Read Only Memory) or other types of static storage devices that can store static information and instructions, a RAM (Random Access Memory) or other types of dynamic storage devices that can store information and instructions, or an EEPROM (Electrically Erasable Programmable Read Only Memory), a CD-ROM (Compact Disc Read Only Memory) or other optical disk storage, optical disk storage (including compressed optical disk, laser disk, optical disk, digital versatile disk, Blu-ray disk, etc.), a disk storage medium or other magnetic storage devices, or any other medium that can be used to carry or store the desired program codes in the form of instructions or data structures and can be accessed by a computer, but is not limited thereto.

The memory 803 is used to store the application codes for executing the solutions of the disclosure, and is controlled by the processor 801 to execute. The processor 801 is used to execute the application codes stored in the memory 803, to implement the content shown in the aforementioned method embodiments.

The electronic devices include but are not limited to: mobile terminals, such as mobile phones, laptops, digital broadcast receivers, PDAs (personal digital assistants), PADs (tablet computers), PMPs (portable multimedia players), vehicle-mounted terminals (such as vehicle-mounted navigation terminals), etc., and fixed terminals such as digital TVs, desktop computers, etc. The electronic device shown in FIG. 8 is only an example and should not impose any restrictions on the functions and scope of use of embodiments of the present disclosure.

The server provided by the present disclosure may be a standalone physical server, or a server cluster or distributed system composed of a plurality of physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal may be a smart phone, a tablet computer, a laptop computer, a desktop computer, a smart speaker, a smart watch, etc., but is not limited thereto. The terminal and the server may be directly or indirectly connected via wired or wireless communication, which is not limited in the present disclosure.

The embodiments of the present disclosure provide a computer-readable storage medium, on which a computer program is stored, and when it is run on a computer, the computer can execute the corresponding contents in the aforementioned method embodiments.

It should be understood that, although the steps in the flowchart of the accompanying drawings are displayed in sequence as indicated by the arrows, these steps are not necessarily executed in the order indicated by the arrows. Unless otherwise specified in this document, the execution of these steps is not strictly limited in order, and they can be executed in other orders. Moreover, at least part of the steps in the flowchart of the accompanying drawings may include multiple sub-steps or multiple stages, and these sub-steps or stages are not necessarily executed at the same time, but can be executed at different times, and their execution order is not necessarily sequential, but can be executed in turn or alternately with other steps or at least part of the sub-steps or stages of other steps.

It should be noted that, the computer-readable medium of the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus or device, or any combination of the above. More specific examples of computer-readable storage media may include, but are not limited to, an electrical link with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in conjunction with an instruction execution system, apparatus, or device. In the present disclosure, a computer-readable signal medium may include a data signal propagated in a baseband or as part of a carrier wave, in which a computer-readable program code is carried. Such propagated data signals may take a variety of forms, including but not limited to electromagnetic signals, optical signals, or any suitable combination of the above. A computer-readable signal medium may also be any computer-readable medium other than a computer-readable storage medium, which may send, propagate, or transmit a program for use by or in conjunction with an instruction execution system, apparatus, or device. The program code contained on the computer-readable medium can be transmitted by any appropriate medium, including but not limited to: wires, optical cables, RF (radio frequency), etc., or any suitable combination of the above.

The above-mentioned computer-readable medium may be contained in the above-mentioned electronic device; or it may exist separately without being assembled into the electronic device.

The above-mentioned computer-readable medium carries one or more programs, and when the above-mentioned one or more programs are executed by the electronic device, the electronic device executes the methods shown in the above-mentioned embodiments.

According to one aspect of the present disclosure, a computer program product or computer program is provided. The computer program product or computer program includes computer instructions, and the computer instructions are stored in a computer-readable storage medium. The processor of the computer device reads the computer instructions from the computer-readable storage medium, and the processor executes the computer instructions, so that the computer device executes the methods provided in the above-mentioned various optional implementations.

The computer program code for performing the operation of the present disclosure can be written in one or more programming languages or a combination thereof, and the above-mentioned programming languages include object-oriented programming languages—such as Java, Smalltalk, C++, and also conventional procedural programming languages—such as “C” language or similar programming languages. The program code may be executed entirely on the user's computer, partially on the user's computer, as a stand-alone software package, partially on the user's computer and partially on a remote computer, or entirely on a remote computer or server. In the case of a remote computer, the remote computer may be connected to the user's computer through any type of network, including a local area network (LAN) or a wide area network (WAN), or may be connected to an external computer (e.g., connected through the Internet using an Internet service provider).

The flowcharts and block diagrams in the accompanying drawings illustrate the possible implementation architectures, functions, and operations of the systems, methods, and computer program products according to various embodiments of the present disclosure. In this regard, each block in the flowchart or block diagram may represent a module, a program segment, or a portion of codes, which contains one or more executable instructions for implementing a specified logical function. It should also be noted that, in some alternative implementations, the functions marked in the block may also occur in an order different from that marked in the accompanying drawings. For example, two blocks represented in succession may actually be executed substantially in parallel, and they may sometimes be executed in a reverse order, depending on the functions involved. It should also be noted that each block in the block diagram and/or flowchart, and the combination of blocks in the block diagram and/or flowchart, can be implemented by a dedicated hardware-based system that performs the specified function or operation, or can be implemented by a combination of dedicated hardware and computer instructions.

The modules involved in the embodiments described in the present disclosure can be implemented by software or by hardware. The name of the module does not constitute a limitation on the module itself in some cases. For example, module A can also be described as “module A for performing operation B”.

The above description is only a preferred embodiment of the present disclosure and an explanation of the adopted technical principles. Those skilled in the art should understand that, the disclosed scope involved in the present disclosure is not limited to the technical solutions formed by a specific combination of the above technical features, but also should cover other technical solutions formed by any combination of the above technical features or their equivalent features without departing from the above concept of the disclosure, for example, technical solutions formed by interchanging the above features with technical features with similar functions disclosed in the present disclosure (but not limited to).

1. A communication method, applied to a first station (STA), comprising:
determining a first frame, wherein the first frame indicates that the first STA requests to establish a TDLS peer Power Save Mode (PSM) mechanism with a second STA on a first link, and the first link is a Tunneled Direct Link Setup (TDLS) channel; and
sending the first frame on a second link with an access point, and indicating the access point to forward the first frame to the second STA.

2. The communication method according to claim 1, wherein the first frame comprises a link identifier information element;
wherein the link identifier information element comprises:
basic service set identifier (BSSID) information, address information of a TDLS initiator of the first link, and address information of a TDLS responder of the first link.

3. The communication method according to claim 2, wherein the TDLS initiator of the first link and the TDLS responder of the first link are multi-link devices, the address information of the TDLS initiator is MAC address information of the multi-link device, and the address information of the TDLS responder is MAC address information of the multi-link device;
the TDLS initiator and/or the TDLS responder are not multi-link devices, the address information of the TDLS initiator is MAC address information of the TDLS initiator on the first link, and the address information of the TDLS responder is MAC address information of the TDLS responder on the first link.

4. The communication method according to claim 2, wherein the BSSID information comprises: BSSID of an access point corresponding to a third link; the third link is a link used to establish the first link.

5. The communication method according to claim 2, wherein the first frame comprises: one or more wakeup schedule information elements, and the link identifier information element corresponding to each wakeup schedule information element.

6. The communication method according to claim 5, wherein an identifier of the wakeup schedule information element is set to a value of the BSSID information in the corresponding link identifier information element.

7. The communication method according to claim 5, wherein the wakeup schedule information element comprises a time synchronization function (TSF) parameter, and the TSF parameter is set to a TSF parameter value in a beacon frame broadcast by the BSSID in the corresponding link identifier information element, or to a TSF parameter value of a link used to send a TDLS setup request frame.

8. The communication method according to claim 1, wherein the first frame comprises a TDLS peer PSM request frame.

9. A communication method, applied to an access point (AP), comprising:
receiving a first frame on a second link with a first station (STA), wherein the first frame indicates that the first STA requests to establish a TDLS peer Power Save Mode (PSM) mechanism with a second STA on a first link, and the first link is a Tunneled Direct Link Setup (TDLS) channel; and
forwarding the first frame to a second STA.

10. The communication method according to claim 9, wherein the first frame comprises a link identifier information element;
wherein the link identifier information element comprises:
basic service set identifier (BSSID) information, address information of a TDLS initiator of the first link, and address information of a TDLS responder of the first link.

11. The communication method according to claim 10, wherein the TDLS initiator of the first link and the TDLS responder of the first link are multi-link devices, the address information of the TDLS initiator is MAC address information of the multi-link device, and the address information of the TDLS responder is MAC address information of the multi-link device;
the TDLS initiator and/or the TDLS responder are not multi-link devices, the address information of the TDLS initiator is MAC address information of the TDLS initiator on the first link, and the address information of the TDLS responder is MAC address information of the TDLS responder on the first link.

12. The communication method according to claim 10, wherein the BSSID information comprises: BSSID of an access point corresponding to a third link; the third link is a link used to establish the first link.

13. The communication method according to claim 10, wherein the first frame comprises: one or more wakeup schedule information elements, and the link identifier information element corresponding to each wakeup schedule information element.

14. The communication method according to claim 13, wherein an identifier of the wakeup schedule information element is set to a value of the BSSID information in the corresponding link identifier information element.

15. The communication method according to claim 13, wherein the wakeup schedule information element comprises a time synchronization function (TSF) parameter, and the TSF parameter is set to a TSF parameter value in a beacon frame broadcast by the BSSID in the corresponding link identifier information element, or to a TSF parameter value of a link used to send a TDLS setup request frame.

16. The communication method according to claim 9, wherein the first frame comprises a TDLS peer PSM request frame.

17. A communication method, applied to a second station (STA), comprising:
receiving a first frame forwarded by an access point (AP), wherein the first frame is received by the AP on a second link with a first STA; the first frame indicates that the first STA requests to establish a TDLS peer Power Save Mode (PSM) mechanism with a second STA on a first link, and the first link is a Tunneled Direct Link Setup (TDLS) channel.

18. The communication method according to claim 17, wherein the first frame comprises a link identifier information element;
wherein the link identifier information element comprises:
basic service set identifier (BSSID) information, address information of a TDLS initiator of the first link, and address information of a TDLS responder of the first link.

19. The communication method according to claim 18, wherein the TDLS initiator of the first link and the TDLS responder of the first link are multi-link devices, the address information of the TDLS initiator is MAC address information of the multi-link device, and the address information of the TDLS responder is MAC address information of the multi-link device;
the TDLS initiator and/or the TDLS responder are not multi-link devices, the address information of the TDLS initiator is MAC address information of the TDLS initiator on the first link, and the address information of the TDLS responder is MAC address information of the TDLS responder on the first link.

20. The communication method according to claim 18, wherein the BSSID information comprises: BSSID of an access point corresponding to a third link; the third link is a link used to establish the first link.

21. The communication method according to claim 18, wherein the first frame comprises: one or more wakeup schedule information elements, and the link identifier information element corresponding to each wakeup schedule information element.

22. The communication method according to claim 21, wherein an identifier of the wakeup schedule information element is set to a value of the BSSID information in the corresponding link identifier information element.

23. The communication method according to claim 21, wherein the wakeup schedule information element comprises a time synchronization function (TSF) parameter, and the TSF parameter is set to a TSF parameter value in a beacon frame broadcast by the BSSID in the corresponding link identifier information element, or to a TSF parameter value of a link used to send a TDLS setup request frame.

24. The communication method according to claim 17, wherein the first frame comprises a TDLS peer PSM request frame.

25.-27. (canceled)

28. An electronic device, comprising a memory, a processor, and a computer program stored in the memory and executable by the processor, wherein the processor implements the method according to claim 1 when executing the program.

29. A non-transitory computer-readable storage medium, having a computer program stored thereon, wherein the computer program implements the method according to claim 1 when executed by a processor.
